(19) United States
(12) Patent Application Publication
(10) Pub. No.: US 2026/0304015 A1
(43) Pub. Date: Oct. 1, 2026

(54) EARPHONE CASE AND CASE STRUCTURE THEREOF

(71) Applicants: Maintek Computer (Suzhou) Co., Ltd., JiangSu (CN); PEGATRON CORPORATION, Taipei City (TW)

(72) Inventors: Yong-Xiang WU, JiangSu (CN); Chia-Hsiang HSIANG, Taipei City (TW); Xue-Bing CHENG, JiangSu (CN)

(21) Appl. No.: 19/530,975

(22) Filed: Feb. 5, 2026

(30) Foreign Application Priority Data
Mar. 26, 2025 (CN) 202510368539.0

(51) Int. Cl. H04R 1/02; H04R 1/10; H04R 1/1025

(52) U.S. Cl. CPC H04R 1/028; H04R 1/1025; H04R 1/1066; H04R 2420/07

(57) ABSTRACT

A case structure of an earphone case, which includes a body, a case cover, a first limiting member, and a second limiting member. The body includes an upper inner wall, a lower inner wall and two side inner walls connecting the upper inner wall and the lower inner wall. The case cover includes a cover body and a pivot portion. The pivot portion includes an extension block. The case cover is connected to the body through the pivot portion. The first limiting member and the second limiting member are respectively disposed on the lower inner wall and the upper inner wall and used to limit the extension block. When the first limiting member limits the extension block, the case cover is located at the closed position. When the second limiting member limits the extension block, the case cover is located at the open position.

### BACKGROUND OF THE INVENTION

### 1. Field of the Invention

The present disclosure relates to a case structure, and more particularly, to a case structure for an earphone case.

### 2. Description of the Related Art

With the development of wireless communication technology, many electronic devices have been improved into a wireless form. For example, the currently widely used Bluetooth earphones can connect with other devices without an earphone cable. For the convenience of carrying and storage, the Bluetooth earphones are usually stored in an earphone case, which also performs charging. Generally, a wireless earphone case includes a body having a charging function and a case cover pivotably connected to the body. In order to facilitate the user to hold or store the Bluetooth earphones, the current wireless earphone case is designed such that the case cover can be directly opened to access the earphones.

In order to prevent the case cover from being inadvertently opened, other methods are required to fix the body and the case cover in a closed state. A common method is to respectively provide mutually attractive magnets on the body and the case cover, and to fix the body and the case cover in the closed state by magnetic attraction. The case cover can be opened by merely applying slight force to the case cover. However, the additional provision of magnets will increase the cost of the earphone case and may also affect the charging module of the earphone case or the stored Bluetooth earphones. Thus, there is a necessity for improvement.

### SUMMARY OF THE INVENTION

In view of the above-mentioned problems, an object of the present disclosure is to provide an earphone case and a case structure thereof. By utilizing the structure and connection relationship of a first limiting member, a second limiting member, and an extension block of a case cover, the problem of high manufacturing cost of a conventional earphone case is solved.

To achieve the above-mentioned object, the present disclosure provides a case structure, comprising: a body, a case cover, a first limiting member, and a second limiting member. The body includes an upper inner wall, a lower inner wall, and two side inner walls connecting the upper inner wall and the lower inner wall. The upper inner wall, the lower inner wall, and the two side inner walls form a concave. The case cover includes a cover body and a pivot portion connected to the cover body. The pivot portion includes an extension block. The case cover is pivotably connected to the body through the pivot portion, and the case cover has a closed position and an open position relative to the body. The first limiting member is disposed on the lower inner wall, and the first limiting member is used to limit the extension block. The second limiting member is disposed on the upper inner wall, and the second limiting member is used to limit the extension block. When the first limiting member limits the extension block, the case cover is in the closed position. When the second limiting member limits the extension block, the case cover is in the open position.

According to an embodiment of the present disclosure, the first limiting member includes two first sheets spaced apart from each other and at least one first limiting portion disposed on the two first sheets. The second limiting member includes two second sheets and at least one second limiting portion disposed between the two second sheets. When the case cover is in the closed position, the extension block is located between the two first sheets and is limited by the at least one first limiting portion. When the case cover is in the open position, the extension block is limited by the two second sheets and the at least one second limiting portion.

According to an embodiment of the present disclosure, the at least one first limiting portion and the at least one second limiting portion are respectively a first bump and a second bump. The number of the first bumps is two, and the number of the second bumps is two. The two first bumps are respectively disposed on the mutually facing side walls of the two first sheets and are disposed opposite to each other. The two second bumps are respectively disposed on the mutually facing side walls of the two second sheets and are disposed opposite to each other.

According to an embodiment of the present disclosure, the number of the second limiting portions is two. The two second limiting portions are respectively disposed on one side wall facing each other of the two second sheets.

According to an embodiment of the present disclosure, the two second bumps are respectively located on the two second sheets and near an end of the two first sheets.

According to an embodiment of the present disclosure, the first limiting member further includes a first panel disposed on the lower inner wall. The two first sheets extend from the first panel toward the upper inner wall. The second limiting member further includes a second panel disposed on the upper inner wall. The two second sheets extend from the first panel toward the lower inner wall.

According to an embodiment of the present disclosure, when the case cover is opened or closed relative to the body, the case cover rotates to drive the extension block to rotate within the concave.

According to an embodiment of the present disclosure, the extension block has a first length from the bottom side of the pivot portion to a bottom edge of the extension block. The distance between the bottom side of the pivot portion and a bottom edge of the case cover has a second length. The first length is greater than the second length.

According to an embodiment of the present disclosure, the case structure further includes an axle, wherein the axle is disposed on the pivot portion, and the case cover is pivotably connected to the two side inner walls of the body through the axle.

According to an embodiment of the present disclosure, the case structure includes an outer shell, wherein the outer shell has an accommodating space. The body is disposed in the accommodating space.

To achieve the above-mentioned object, the present disclosure further provides an earphone case, which includes the aforementioned case structure and an earphone, wherein the earphone is disposed in the case structure.

As described above, the earphone case and the case structure thereof according to the present disclosure include the body, the case cover, the first limiting member, and the second limiting member. The case cover includes the cover body and a pivot portion connected to the cover body. The case cover is pivotably connected to the body through the pivot portion. The pivot portion includes the extension block. The first limiting member and the second limiting member are respectively disposed on the lower inner wall and the upper inner wall of the body and are used to limit the extension block. In other words, the first limiting member and the second limiting member can fix the case cover relative to the body at the closed position and the open position without additionally providing magnets, thereby reducing manufacturing costs. In addition, compared to a conventional earphone case that uses magnetic positioning, using the first limiting member and the second limiting member can also avoid the magnets affecting the stored Bluetooth earphones or charging module.

### BRIEF DESCRIPTION OF THE DRAWINGS

All of the objects and advantages of the present invention will become apparent from the following description of the accompanying drawings, which disclose several embodiments of the present invention. It should be understood that the drawings are used for purposes of illustration only, and not as a definition of the invention.

FIG. 1 is a schematic diagram of a case structure of an earphone case according to an embodiment of the present disclosure.

FIG. 2 is an exploded schematic diagram of the case structure shown in FIG. 1.

FIG. 3 is a schematic diagram illustrating a first limiting member and a second limiting member disposed in a concave of a body shown in FIG. 2.

FIG. 4A is a schematic diagram illustrating a case cover assembled to the body through an axle shown in FIG. 2.

FIG. 4B is an exploded schematic diagram of the case cover and a base shown in FIG. 2.

FIG. 4C is an enlarged schematic diagram of the case cover shown in FIG. 1.

FIG. 5A is a cross-sectional schematic diagram of the assembled case structure shown in FIG. 2.

FIG. 5B is an enlarged schematic diagram of the case structure at the concave shown in FIG. 5A.

FIG. 6A is a cross-sectional schematic diagram of the case structure shown in FIG. 1.

FIG. 6B is an enlarged schematic diagram of the case structure at the concave shown in FIG. 6A.

FIG. 7 is an enlarged schematic diagram of region A shown in FIG. 5A.

### DETAILED DESCRIPTION OF THE PREFERRED EMBODIMENTS

Preferred specific embodiments are given below for better understanding of the technical contents of the present invention.

For the convenience and clarity of description, the maximum width or dimension of each element in the drawings is exaggerated or omitted or schematically represented to facilitate the understanding and reading of those skilled in the art. The dimensions of each element are not intended to be their actual dimensions and are not intended to limit the implementable conditions of the present disclosure. Therefore, they do not have substantial technical significance. Any structural modification, change in proportional relationship, or adjustment in size should still fall within the scope covered by the technical content disclosed herein, without affecting the efficacy and achievable objectives of the present disclosure. The same reference numerals are used throughout the drawings to designate the same or similar elements.

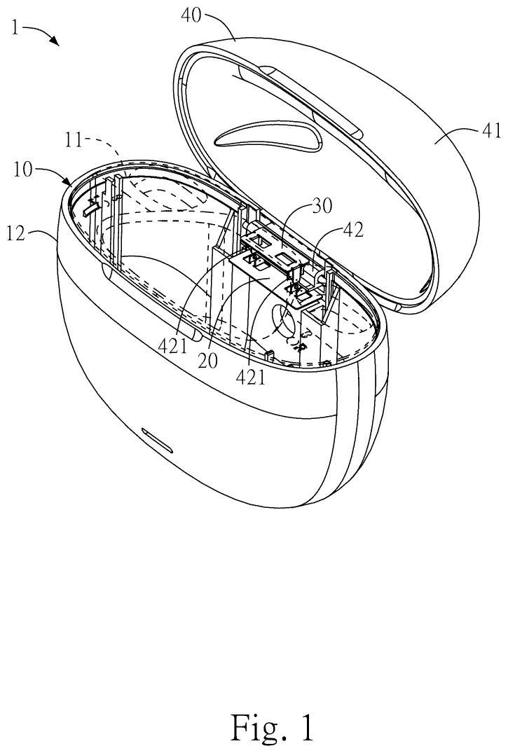

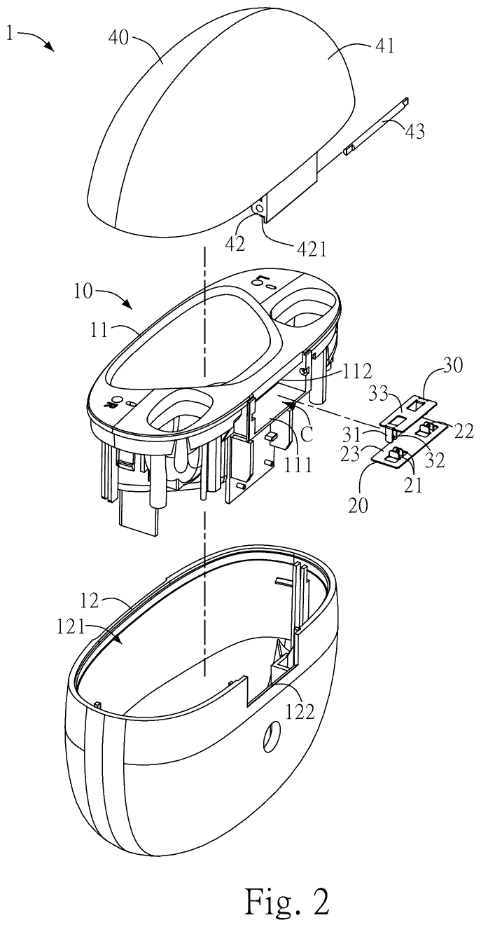

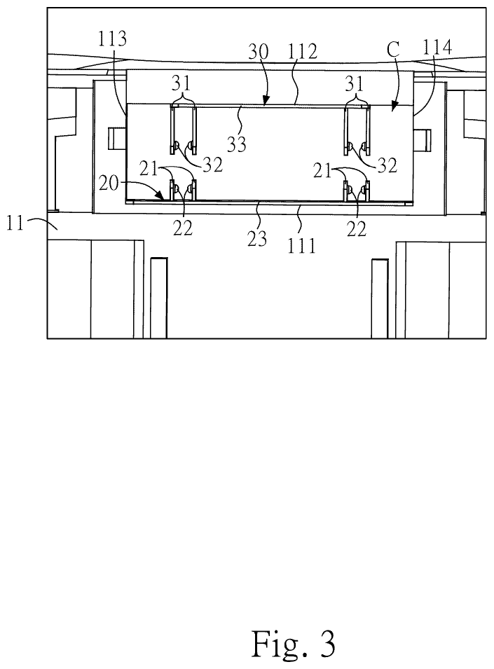

FIG. 1 is a schematic diagram of a case structure of an earphone case according to an embodiment of the present disclosure, FIG. 2 is an exploded schematic diagram of the case structure shown in FIG. 1, and FIG. 3 is a schematic diagram illustrating a first limiting member and a second limiting member disposed in a concave of a body shown in FIG. 2. Please refer to FIG. 1, FIG. 2, and FIG. 3 first. In this embodiment, the earphone case includes a case structure 1 and an earphone (not shown). The earphone is disposed in the case structure 1. The technical features of the present disclosure reside in the case structure 1, which will be further described below. The case structure 1 of this embodiment includes a base 10, a first limiting member 20, a second limiting member 30, and a case cover 40. As shown in FIG. 2, the base 10 includes a body 11 and an outer shell 12. The outer shell 12 has an accommodating space 121, and the body 11 is disposed in the accommodating space 121, such that the body 11 and the outer shell 12 jointly form the base 10. Furthermore, the body 11 includes a lower inner wall 111, an upper inner wall 112, and two side inner walls 113 and 114 connecting the lower inner wall 111 and the upper inner wall 112. The lower inner wall 111, the upper inner wall 112, and the two side inner walls 113, 114 form a concave C. Specifically, the concave C includes an opening facing outwards, and the lower inner wall 111 and the upper inner wall 112 are adjacent to the opening, as shown in FIG. 2. Furthermore, the lower inner wall 111 and the upper inner wall 112 are respectively the inner walls of the lower side and the upper side of the concave C, and correspondingly, the two side inner walls 113 and 114 are the inner walls of the left side and the right side of the concave C, as shown in FIG. 3. Preferably, the outer shell 12 further has a recessed opening 122 corresponding to the position of the concave C, used for accommodating a portion of the structure of the case cover 40.

Please refer to FIG. 2 and FIG. 3. The first limiting member 20 and the second limiting member 30 are both located within the concave C. The first limiting member 20 is disposed on the lower inner wall 111, and the first limiting member 20 at least partially extends in a direction toward the upper inner wall 112. The second limiting member 30 is disposed on the upper inner wall 112, and the second limiting member 30 at least partially extends in a direction toward the lower inner wall 111. In other words, the first limiting member 20 and the second limiting member 30 are disposed opposite to each other within the concave C, and at least portions of their structures extend toward each other, so that the first limiting member 20 and the second limiting member 30 are configured to limit the case cover 40 in different states.

Specifically, the first limiting member 20 of the present embodiment includes at least two first sheets 21 spaced apart from each other and at least one first limiting portion 22 disposed on the first sheet 21. One end of the first sheet 21 is located at the lower inner wall 111, and the other end extends in a direction toward the upper inner wall 112. Preferably, the first limiting member 20 of the present embodiment further includes a first panel 23, which is disposed on the lower inner wall 111. The first sheets 21 extend from the first panel 23 toward the upper inner wall 112. Furthermore, two of the first sheets 21 are spaced apart to form a channel, and the first limiting portion 22 is located between the channel formed by the two first sheets 21. Preferably, the first limiting portion 22 can be a bump, which is referred to as a first bump in the present disclosure. In one embodiment, if the number of the first bumps (i.e., the first limiting portion 22) is one, the first bump (i.e., the first limiting portion 22) may be disposed on a side wall of one of the first sheets 21, and the side wall is facing the other first sheet 21, so that the first limiting portion 22 can be located between the two first sheets 21. In this embodiment, the number of the first bumps (i.e., the first limiting portion 22) is two. The two first bumps (i.e., the first limiting portion 22) may be respectively disposed on the mutually facing side walls of the two first sheets 21 and are disposed opposite to each other.

It should be noted that the present disclosure does not limit the number of the first sheets 21 and the first limiting portions 22. In this embodiment, the first limiting member 20 has four first sheets 21 and four first limiting portions 22. Among them, two first sheets 21 are spaced apart to form a channel. The four first sheets 21 of this embodiment form two channels. Furthermore, the four first limiting portions 22 are respectively disposed on the mutually facing side walls of the two first sheets 21 that are spaced apart, so as to be located within the channel. In other embodiments, the number of the first sheets 21 and the first limiting portions 22 may also be other quantities, which is not limited by the present disclosure.

Similarly, the second limiting member 30 of the present embodiment also includes at least two second sheets 31 spaced apart from each other, at least one second limiting portion 32 disposed on the two second sheets 31, and a second panel 33. The second panel 33 is disposed on the upper inner wall 112. The second sheets 31 extend from the second panel 33 in a direction toward the lower inner wall 111. Likewise, two of the second sheets 31 are spaced apart to jointly form a channel, and the second limiting portion 32 is located between the channel formed by the two second sheets 31. Similarly, the second limiting portion 32 is preferably a bump, which is referred to as a second bump in the present disclosure. In this embodiment, the number of the second bumps (i.e., the second limiting portion 32) is two. The two second bumps (i.e., the second limiting portion 32) may be respectively disposed on the mutually facing side walls of the two second sheets 31 and are disposed opposite to each other, so as to be located within the channel. In this embodiment, the second limiting member 30 has four second sheets 31 and four second limiting portions 32. Two of the second limiting portions 32 are respectively disposed on the mutually facing side walls of the two second sheets 31 that are spaced apart, so as to be located within the channel. In other embodiments, the number of the second sheets 31 and the second limiting portions 32 may also be other quantities, which is not limited by the present disclosure.

Preferably, the first limiting member 20 and the second limiting member 30 may be made of a metallic material, such as an iron sheet. The first sheets 21, the first limiting portions 22, the second sheets 31, and the second limiting portions 32 can be manufactured by stamping the first panel 23 and the second panel 33 directly.

In this embodiment, the first panel 23 and the second panel 33 are not connected, so that the first limiting member 20 and the second limiting member 30 are mutually independent components, and are respectively disposed on the lower inner wall 111 and the upper inner wall 112. The first sheets 21 and the second sheets 31 extend toward each other, respectively in the direction of the upper inner wall 112 and the lower inner wall 111. In other embodiments, the first panel 23 and the second panel 33 may be connected to each other, so that the first limiting member 20 and the second limiting member 30 form an integrated structure, which is not limited by the present disclosure.

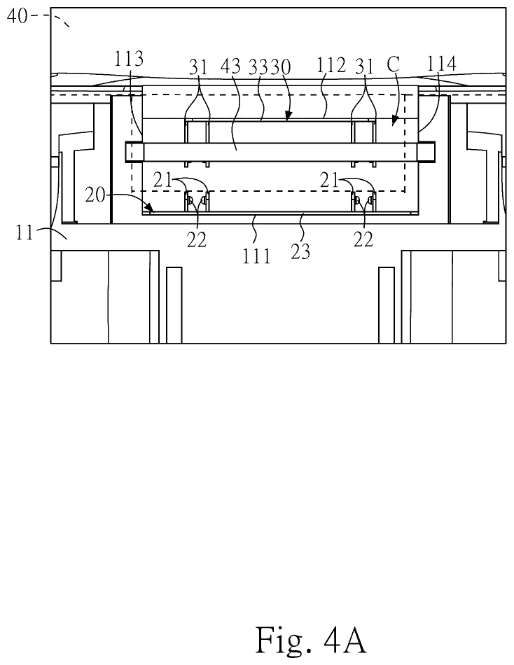

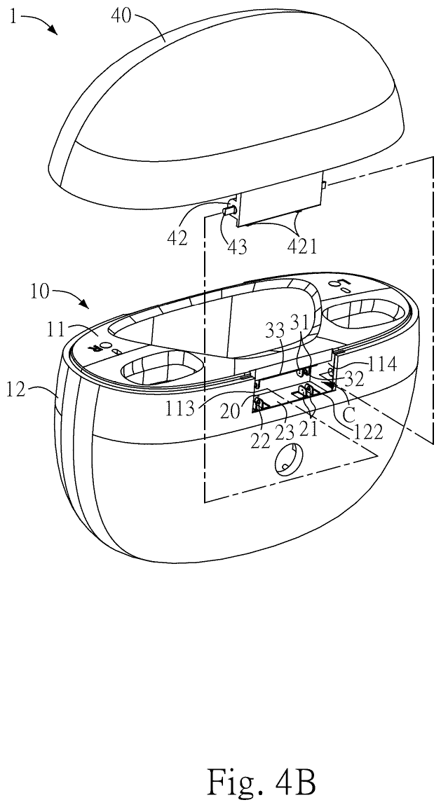

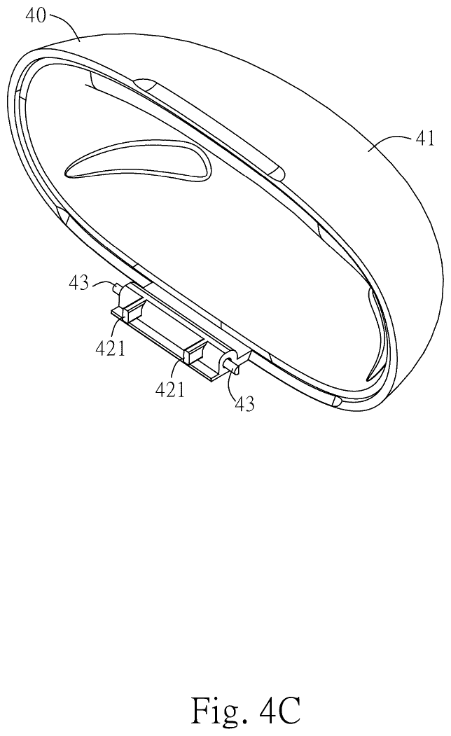

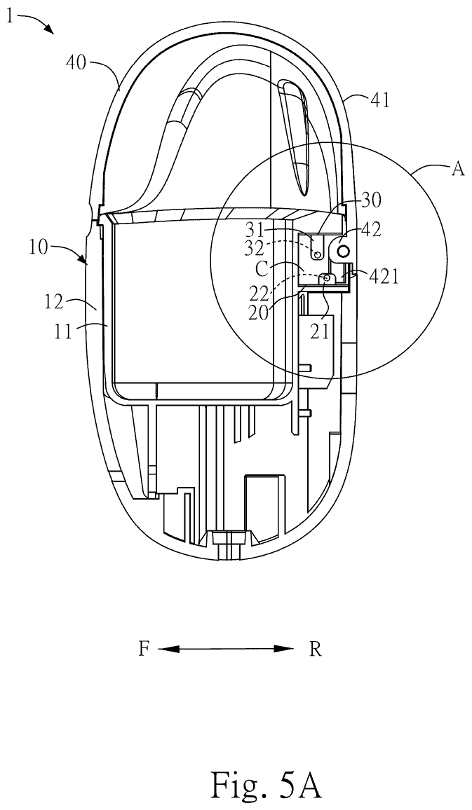

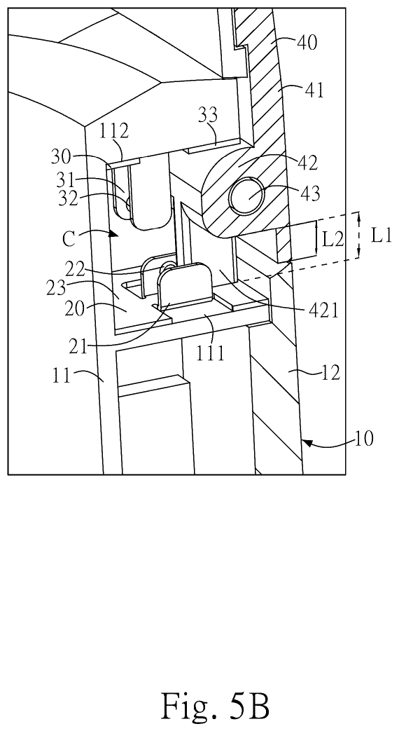

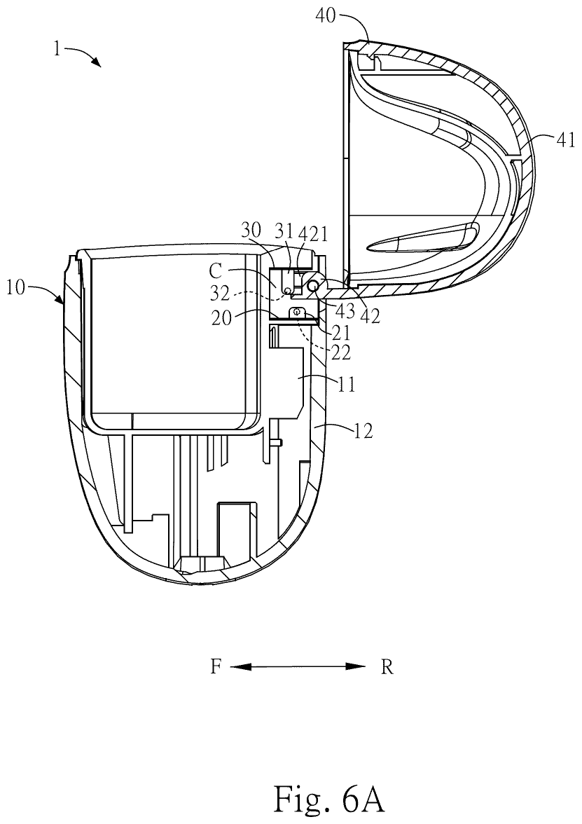

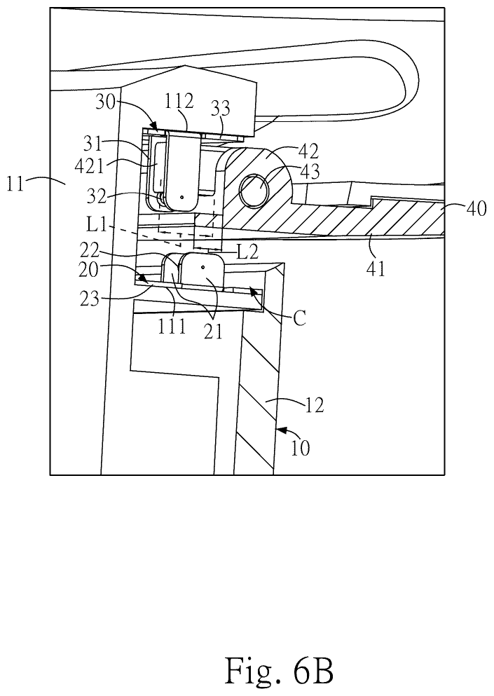

FIG. 4A is a schematic diagram illustrating the case cover assembled to the body through an axle shown in FIG. 2, FIG. 4B is an exploded schematic diagram of the case cover and the base shown in FIG. 2, FIG. 4C is an enlarged schematic diagram of the case cover shown in FIG. 1, FIG. 5A is a cross-sectional schematic diagram of the assembled case structure shown in FIG. 2, FIG. 5B is an enlarged schematic diagram of the case structure at the concave shown in FIG. 5A, FIG. 6A is a cross-sectional schematic diagram of the case structure shown in FIG. 1, and FIG. 6B is an enlarged schematic diagram of the case structure at the concave shown in FIG. 6A. Among them, FIGS. 5A and 5B are schematic diagrams showing the case cover 40 in a closed position, while FIGS. 6A and 6B are schematic diagrams showing the case cover 40 in an open position relative to the body 11. Please refer to FIGS. 4A, 4B, 5A, and 5B first. The case cover 40 of the present embodiment is pivotably connected to the body 11. The case cover 40 includes a cover body 41 and a pivot portion 42 connected to the cover body 41. As shown in FIG. 4C, the pivot portion 42 includes at least one extension block 421. It should be noted that the pivot portion 42 of this embodiment has two extension blocks 421, which respectively correspond to the two channels formed by the four first sheets 21 and the two channels formed by the four second sheets 31. Similarly, the present disclosure does not limit the number of the extension blocks 421, which is preferably half the number of the first sheets 21 or the second sheets 31, so as to cooperate with the channels formed by the first sheets 21 or the second sheets 31.

Specifically, the case cover 40 of the present embodiment preferably further includes a pivot portion 42. The extension block 421 is disposed on the bottom side of the pivot portion 42 facing the body 11, as shown in FIGS. 5B and 6B. When the case cover 40 is assembled to the body 11, the outer side of the pivot portion 42 is located in the recessed opening 122 of the outer shell 12, and the extension block 421 and the pivot portion 42 are located within the concave C. Please refer to FIGS. 2, 4A, and 4B. The case structure 1 includes an axle 43 disposed on the pivot portion 42. In this embodiment, the axle 43 passes through the pivot portion 42, so that the axle 43 protrudes from two opposite ends of the pivot portion 42 and is pivotably connected to the body 11. That is, the case cover 40 is pivotably connected to the body 11 through the axle 43. Furthermore, the axle 43 of this embodiment is pivotably connected to the concave C located in the body 11. It should be noted that, in order to clearly show the connection relationship between the case cover 40 and the concave C of the body 11, the axle 43 in FIG. 4A is represented by a solid line, and the cover body 41 and the pivot portion 42 are represented by dashed lines.

Preferably, the two side inner walls 113, 114 have axle holes near the opening of the concave C. The two opposite ends of the axle 43 are respectively accommodated in the axle holes of the two side inner walls 113, 114, so that the two opposite ends of the axle 43 are respectively pivotably connected to the two side inner walls 113, 114 of the concave C.

The case cover 40 of the present embodiment is pivotably connected to the body 11 through the pivot portion 42, so that the case cover 40 has a closed position and an open position relative to the body 11. Furthermore, when the case cover 40 is opened or closed relative to the body 11, the case cover 40 rotates to drive the extension block 421 to rotate within the concave C. That is, the extension block 421 also moves between the closed position (as shown in FIGS. 5A and 5B) and the open position (as shown in FIGS. 6A and 6B) as the case cover 40 rotates relative to the body 11. The first limiting member 20 and the second limiting member 30 are used to limit the extension block 421 at different positions. In this embodiment, when the first limiting member 20 limits the extension block 421, the case cover 40 is in the closed position, as shown in FIGS. 5A and 5B. When the case cover 40 is in the closed position, the extension block 421 is located between the two first sheets 21 and is limited by the first limiting portion 22. Specifically, the first limiting member 20 abuts against the front side surface of the extension block 421 (i.e., the side surface facing the concave C), thereby fixing the case cover 40 in the closed position. Specifically, the extension block 421 is located between the two first sheets 21 and within the channel formed by the two first sheets 21. Furthermore, the first limiting portion 22 (i.e., the first bump) located between the two first sheets 21 abuts against the front side surface of the extension block 421, thereby fixing the entire case cover 40 in the closed position. Preferably, when in the closed position, the bottom side of the extension block 421 is in contact with the first panel 23 disposed on the lower inner wall 111.

When the second limiting member 30 limits the extension block 421, the case cover 40 is in the open position relative to the body 11, as shown in FIGS. 6A and 6B. When the case cover 40 is in the open position, the extension block 421 is limited by the two second sheets 31 and the second limiting portion 32. Specifically, when the case cover 40 needs to be opened, force is merely applied to the side opposite to the pivot portion 42. Taking FIG. 5A as an example, force is applied from a front F of the case cover 40 toward a rear R, so that the case cover 40 rotates toward the rear R around the axle 43 as the axis. At this time, the extension block 421 moves toward the front F and upward (i.e., toward the lower inner wall 111) along with the pivot portion 42. When the extension block 421 moves from the closed position to the open position as the case cover 40 rotates, the extension block 421 first pries open the first sheets 21 and moves out, and then pries open the second sheets 31 and enters the channel formed by the second sheets 31, as shown in FIGS. 6A and 6B. Specifically, the extension block 421 first enters the channel formed by two adjacent second sheets 31 with its front side surface, and pries open the two second sheets 31, so that the entire extension block 421 is located between the second sheets 31. At this time, the second limiting portion 32 abuts against the rear side surface of the extension block 421, thereby fixing the case cover 40 in the open position. In other words, when the case cover 40 is in the open position, the second limiting member 30 abuts against the rear side surface of the extension block 421.

Preferably, the second limiting portion 32 (i.e., the two second bumps) of the present embodiment are respectively located on the two second sheets 31 and are near an end of the first sheets 21, meaning they are near the end of the second sheets 31. Furthermore, the distance from the upper inner wall 112 to the second limiting portion 32 (i.e., the second bump) is slightly greater than the width of the extension block 421. By the foregoing limitation, the extension block 421 can be exactly accommodated between the two second sheets 31, so as to achieve the effect of avoiding wasted space.

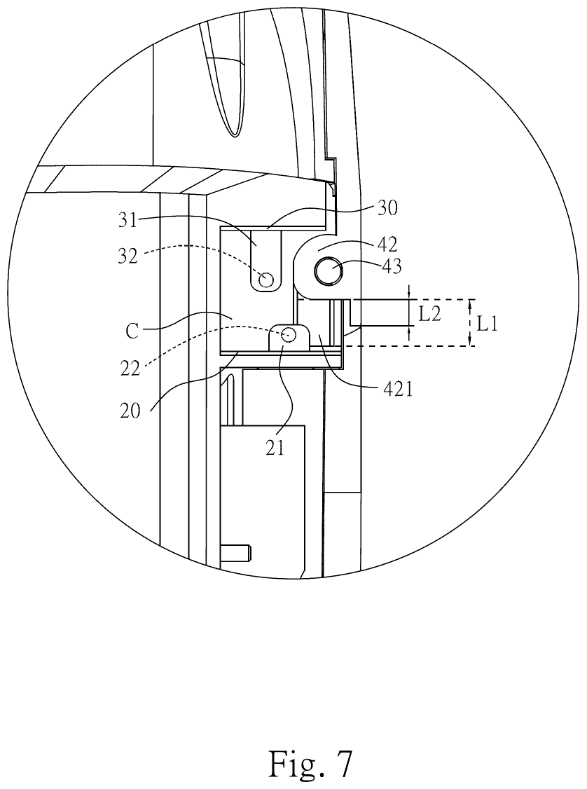

FIG. 7 is an enlarged schematic diagram of region A shown in FIG. 5A. Please refer to FIGS. 5B, 6B, and 7. Preferably, the extension block 421 of the present embodiment has a first length L1 from the bottom side of the pivot portion 42 to its bottom edge. The distance between the bottom side of the pivot portion 42 and a bottom edge of the case cover 40 has a second length L2. The first length L1 is greater than the second length L2. Therefore, when the case cover 40 rotates relative to the body 11, interference between the bottom edge of the case cover 40 (i.e., the structure below the bottom side of the pivot portion 42) and the structure within the concave C can be avoided

In summary, the earphone case and the case structure thereof according to the present disclosure include the body, the case cover, the first limiting member, and the second limiting member. The case cover includes the cover body and a pivot portion connected to the cover body. The case cover is pivotably connected to the body through the pivot portion. The pivot portion includes an extension block. The first limiting member and the second limiting member are respectively disposed on the lower inner wall and the upper inner wall of the body and are used to limit the extension block. In other words, the first limiting member and the second limiting member can fix the case cover relative to the body at the closed position and the open position without additionally providing magnets, thereby reducing manufacturing costs. In addition, compared to a conventional earphone case that uses magnetic positioning, using the first limiting member and the second limiting member can also avoid the magnets affecting the stored Bluetooth earphones or charging module.

It is noted that the above-mentioned embodiments are only for illustration. It is intended that the present invention cover modifications and variations of this invention provided they fall within the scope of the following claims and their equivalents. Therefore, it will be apparent to those skilled in the art that various modifications and variations can be made to the structure of the present invention without departing from the scope or spirit of the invention.

What is claimed is:

1. A box structure, including:
a body, including an upper inner wall, a lower inner wall, and two side inner walls connecting the upper inner wall and the lower inner wall, wherein the upper inner wall, the lower inner wall, and the two side inner walls form a concave;
a case cover, including a cover body and a pivot portion connecting the cover body, wherein the pivot portion includes an extension block, and the case cover is pivoted to the body through the pivot portion, wherein the case cover relative to the body has a closed position and an open position;
a first limiting member, set on the lower inner wall, used to limit the extension block; and
a second limiting member, set on the upper inner wall, used to limit the extension block;
wherein, when the first limiting member limits the extension block, the case cover is located at the closed position;
wherein, when the second limiting member limits the extension block, the case cover is located at the open position.

2. The case structure as claimed in claim 1, wherein the first limiting member includes two first sheets spaced apart from each other and at least one first limiting portion disposed on the two first sheets; the second limiting member includes two second sheets spaced apart from each other and at least one second limiting portion disposed on the two second sheets; when the case cover is located at the closed position, the extension block is located between the two first sheets and is limited by the at least one first limiting portion; when the case cover is located at the open position, the extension block is limited by the two second sheets and the at least one second limiting portion.

3. The case structure as claimed in claim 2, wherein the at least one first limiting portion and the at least one second limiting portion are respectively a first bump and a second bump, the number of the first bumps is two, the number of the second bumps is two, the two first bumps are respectively disposed on the opposite sides of the two first sheets and arranged correspondingly, and the two second bumps are respectively disposed on the opposite sides of the two second sheets and arranged correspondingly.

4. The case structure as claimed in claim 3, wherein the two second bumps are respectively located on the two second sheets and are close to the end of the two first sheets.

5. The case structure as claimed in claim 2, wherein the first limiting member further includes a first panel, which is disposed on the lower inner wall, and the two first sheets extend from the first panel towards the upper inner wall; the second limiting member further includes a second panel, which is disposed on the upper inner wall, and the two second sheets extend from the first panel towards the lower inner wall.

6. The case structure as claimed in claim 5, wherein the first panel and the second panel are connected to each other, so that the first limiting member and the second limiting member form an integrated structure.

7. The case structure as claimed in claim 5, wherein when in the closed position, the bottom side of the extension block is in contact with the first panel disposed on the lower inner wall.

8. The case structure as claimed in claim 1, wherein when the case cover is opened or closed relative to the body, the case cover rotates to drive the extension block to rotate within the concave.

9. The case structure as claimed in claim 8, wherein when the extension block moves from the closed position to the open position as the case cover rotates, the extension block first pries open the first sheets and moves out, and then pries open the second sheets and enters the channel formed by the second sheets.

10. The case structure as claimed in claim 1, wherein the extension block has a first length from the bottom side of the pivot portion to a bottom edge of the extension block, and the bottom side of the pivot portion and a bottom edge of the box cover are separated by a second length, wherein the first length is greater than the second length.

11. The case structure as claimed in claim 10 further includes an axle, the axle being disposed on the pivot portion, the case cover pivotably connected to the two side inner walls of the body through the axle.

12. The case structure as claimed in claim 11, wherein the two side inner walls have axle holes near the opening of the concave.

13. The case structure as claimed in claim 12, wherein the two opposite ends of the axle are respectively accommodated in the axle holes of the two side inner walls.

14. The case structure as claimed in claim 1, wherein the structure further includes an outer shell, the outer shell having an accommodating space, the body being disposed within the accommodating space.

15. An earphone case, including:
a case structure as claimed in claim 1; and
an earphone, disposed in the case structure.
